(19) United States
(12) Patent Application Publication
(10) Pub. No.: US 2002/0174225 A1
(43) Pub. Date: Nov. 21, 2002

(54) Fractional replication in a directory server

(76) Inventors: Mark C. Smith, Saline, MI (US); Gordon Good, Mountain View, CA (US)

Correspondence Address: ROSENTHAL & OSHA L.L.P., 1221 MCKINNEY AVENUE, SUITE 2800, HOUSTON, TX, 77010, US

(21) Appl. No.: 09/849,826

(22) Filed: May 4, 2001

(51) Int. Cl. G06F 15/16; G06F 15/173

(52) U.S. Cl. 709/226; 709/203

(57) ABSTRACT

A method of fractional replication in a directory server includes determining a fractional portion of an entry stored on a primary server using a replication agreement, replicating the fractional portion from the primary server to a replica server creating a fractional replica, and connecting a client computer to the fractional replica. The client computer has knowledge of only the fractional replica.

### BACKGROUND OF INVENTION

The most fundamental program resident on any computer is the operating system (OS). Various operating systems exist in the market place, including Solaris™ from Sun Microsystems Inc., Palo Alto, Calif. (Sun Microsystems), Macintosh® from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform”. Prior to the popularity of the Internet, software developers wrote programs specifically designed for individual traditional platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Prior art FIG. 1 illustrates a conceptual arrangement wherein a first computer (2) running the Solaris™ platform and a second computer (4) running the Windows® 98 platform are connected to a server (8) via the Internet (6). A resource provider using the server (8) might be any type of business, governmental, or educational institution. The resource provider (8) needs to be able to provide its resources to both the user of the Solaris™ platform and the user of the Windows® 98 platform, but does not have the luxury of being able to custom design its content for the individual traditional platforms.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 2 called the Internet Service Deployment Platform (ISDP) (28). ISDP (28) gives businesses a very broad, evolving, and standards-based foundation upon which to build an e-enabled solution.

ISDP (28) incorporates all the elements of the Internet portion of the stack and joins the elements seamlessly with traditional platforms at the lower levels. ISDP (28) sits on top of traditional operating systems (30) and infrastructures (32). This arrangement allows enterprises and service providers to deploy next generation platforms while preserving “legacy-system” investments, such as a mainframe computer or any other computer equipment that is selected to remain in use after new systems are installed.

ISDP (28) includes multiple, integrated layers of software that provide a full set of services supporting application development, e.g., business-to-business exchanges, communications and entertainment vehicles, and retail Web sites. In addition, ISDP (28) is a platform that employs open standards at every level of integration enabling customers to mix and match components. ISDP (28) components are designed to be integrated and optimized to reflect a specific business need. There is no requirement that all solutions within the ISDP (28) are employed, or any one or more is exclusively employed.

In a more detailed review of ISDP (28) shown in FIG. 2, the iPlanet™ deployment platform consists of the several layers. Graphically, the uppermost layer of ISDP (28) starts below the Open Digital Marketplace/Application strata (40).

The uppermost layer of ISDP (28) is a Portal Services Layer (42) that provides the basic user point of contact, and is supported by integration solution modules such as knowledge management (50), personalization (52), presentation (54), security (56), and aggregation (58).

Next, a layer of specialized Communication Services (44) handles functions such as unified messaging (68), instant messaging (66), web mail (60), calendar scheduling (62), and wireless access interfacing (64).

A layer called Web, Application, and Integration Services (46) follows. This layer has different server types to handle the mechanics of user interactions, and includes application and Web servers. Specifically, iPlanet™ offers the iPlanet™ Application Server (72), Web Server (70), Process Manager (78), Enterprise Application and Integration (EAI) (76), and Integrated Development Environment (IDE) tools (74).

Below the server strata, an additional layer called Unified User Management Services (48) is dedicated to issues surrounding management of user populations, including Directory Server (80), Meta-directory (82), delegated administration (84), Public Key Infrastructure (PKI) (86), and other administrative/access policies (88). The Unified User Management Services layer (48) provides a single solution to centrally manage user account information in extranet and e-commerce applications. The core of this layer is iPlanet™ Directory Server (80), a Lightweight Directory Access Protocol (LDAP)-based solution that can handle more than 5,000 queries per second.

iPlanet™ Directory Server (iDS) provides a centralized directory service for an Intranet or extranet while integrating with existing systems. The term directory service refers to a collection of software, hardware, and processes that store information and make the information available to users. The directory service generally includes at least one instance of the iDS and one or more directory client programs. Client programs can access names, phone numbers, addresses, and other data stored in the directory.

One common directory service is a Domain Name System (DNS) server. The DNS server maps computer host names to Internet Protocol (IP) addresses. Thus, all of the computing resources (hosts) become clients of the DNS server. The mapping of host names allows users of the computing resources to easily locate computers on a network by remembering host names rather than numerical IP addresses. The DNS server only stores two types of information, but a typical directory service stores virtually unlimited types of information.

The iDS is a general-purpose directory that stores all information in a single, network-accessible repository. The iDS provides a standard protocol and application programming interface (API) to access the information contained by the iDS.

The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

X.500 and X.400 are the corresponding Open Systems Interconnect (OSI) standards. LDAP supports X.500 Directory Access Protocol (DAP) compatibilities and can easily be embedded in lightweight applications (both client and server) such as email, web browsers, and groupware. LDAP originally enabled lightweight clients to communicate with X.500 directories. LDAP offers several advantages over DAP, including that LDAP runs on TCP/IP rather than the OSI stack, LDAP makes modest memory and CPU demands relative to DAP, and LDAP uses a lightweight string encoding to carry protocol data instead of the highly structured and costly X.500 data encodings.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system he or she needs to access, a single directory entry is created for the user in the LDAP directory. FIG. 3 shows a portion of a typical directory with different entries corresponding to real-world objects. The directory depicts an organizational entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result or results back to the client as a series of LDAP messages. Referring to FIG. 4, when an LDAP client (100) searches the directory for a specific entry, the client (100) constructs an LDAP search request message and sends it the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers, like the iDS, have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

A typical complete LDAP client/server exchange might proceed as depicted in FIG. 5. First, the LDAP client (100) opens a TCP connection to the LDAP server (102) and submits the bind operation (step 111). This bind operation includes the name of the directory entry that the client wants to authenticate as, along with the credentials to be used when authenticating. Credentials are often simple passwords, but they might also be digital certificates used to authenticate the client (100). After the directory has verified the bind credentials, the directory returns a success result to the client (100) (step 112). Then, the client (100) issues a search request (step 113). The LDAP server (102) processes this request, which results in two matching entries (steps 114 and 115). Next, the LDAP server (102) sends a result message (step 116). The client (100) then issues the unbind request (step 117), which indicates to the LDAP server (102) that the client (100) wants to disconnect. The LDAP server (102) obliges by closing the connection (step 118).

By combining a number of these simple LDAP operations, directory-enabled clients can perform useful, complex tasks. For example, an electronic mail client can look up mail recipients in a directory, and thereby, help a user address an e-mail message.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 6 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

As the popularity of the Internet has increased, business entities of all sizes are using Internet technology to communicate with and provide information to a large number of people, including employees, vendors, clients, and customers. Often, the business entity only wants a particular class of people to have access to portions of information stored in a particular record while excluding other information in the same record. An example is an employee having access to a phone directory containing the name, position, phone number, and e-mail of an employee record. Excluded from access in the employee record is salary, benefits, age, etc.

The iDS accomplishes the task of selectively displaying particular portions of information stored in a particular record with a concept referred to as fractional replication. Generally, fractional replication is the capability to replicate a subset of attributes of any given entry in a directory. For example, when replicating directory entries from an Intranet directory server behind a corporate firewall to an extranet server outside the firewall, “public” attributes such as an e-mail address and office telephone number for an entry are the only selected attributes to be replicated. With fractional replication, only selected attributes of the entry are replicated.

In a replication system, the terms supplier and consumer are used to identify the source and destination of replication updates, respectively. A supplier server sends updates to another server; a consumer server accepts those changes. These roles are not mutually exclusive because a server that is a consumer may also be a supplier.

A natural way to describe a set of entries to be replicated is to specify the DN at the top of a subtree and replicate all entries below (subordinate) to the subtree. As shown in FIG. 7, prior to replication, a primary server (200) has a set of entries with the DN of the top of the subtree being ou=accounting (206).

The entries below are cn=John Doe (208), cn=Jane Doe (210), and cn=Jack Smith (212). After replication, a replica server (202) has a set of entries with the DN of the top of the subtree still being ou=accounting (216). The entries below are still cn=John Doe (218), cn=Jane Doe (220), and cn=Jack Smith (222). The only difference is that the subtree is now stored on the replica server (202).

Sparse replication is replication in which only a subset of entries is selected, i.e., only certain entries from a subtree are of interest to be selected. A reasonable request is to select entries based on an object class. For example, only those entries that represent people or organizational units are sought to replicate as shown in FIG. 8. The object class that equals the organizational unit (ou=accounting (232)), the first person (cn=Jane Doe (236)), the second person (cn=Jack Smith (238)), or the organization (dc=company (230)) is replicated to the replica server (202). The resulting set of entries stored on the replica server (202) is the organizational unit (ou=accounting (242)), the first person (cn=Jane Doe (244)), the second person (cn=Jack Smith (246)), and the organization (dc=company (240)). The object class that equals printer (cn=Laser Printer (234)) is not replicated.

Fractional replication, which is fundamentally distinct from sparse replication, is where all entries are replicated, but only a subset of the attributes in those entries are replicated as shown in FIG. 9. For example, when providing a publicly searchable directory of employee information outside the corporate firewall (254) accessible by the Internet (6), an organization may elect to replicate only public attributes, such as full names, e-mail addresses, and office telephone numbers and omit all other personal information. Notice in FIG. 10 that the copy of a John Doe entry (258) stored on the replica server (202) accessible outside the firewall (254) contains fewer attributes than a master entry (260) stored on the primary server (200) inside the firewall (254).

### SUMMARY OF INVENTION

In general, in one aspect, the invention involves a method of fractional replication in a directory server. The method includes determining a fractional portion of an entry stored on a primary server using a replication agreement, replicating the fractional portion from the primary server to a replica server creating a fractional replica, and connecting a client computer to the fractional replica. The client computer has knowledge of only the fractional replica.

In one aspect, the invention involves a method of fractional replication in a directory server. The method includes determining a fractional portion of an entry stored on a primary server using a replication agreement, replicating the fractional portion from the primary server to a replica server creating a fractional replica, using a query rule to govern responses to questions in the absence of entries on the replica server, using a query rule to govern responses to questions in the absence of attributes of the entry on the replica server, updating the fractional portion using a plurality of change types stored in a change record in a database, and connecting a client computer to the fractional replica. The client computer has knowledge of only the fractional replica.

In one aspect, the invention involves a method of transmitting updates to a fractional portion, including retrieving a change record stored in a database, making a pass-through of a plurality of change types from the change record stored in the database, and performing an update function to the fractional portion based on the change type.

In one aspect, the invention involves a directory server system allowing fractional replication. The system includes a primary server database comprising a plurality of entries, an entry filtering rule database to determine a fractional portion of an entry stored on the primary server to be replicated using a replication agreement, and a replica server that replicates the fractional portion received from the primary server creating a fractional replica. A client computer is connected to the fractional replica having knowledge of only the fractional replica of the entry.

In one aspect, the invention involves a directory server system allowing fractional replication, including a primary server database comprising a plurality of entries, an entry filtering rule database to determine a fractional portion of an entry stored on the primary server to be replicated using a replication agreement, a replica server replicates the fractional portion received from the primary server creating a fractional replica, a query rule to govern responses to questions in the absence of entries on the replica server, a query rule to govern responses to questions in the absence of attributes of the entry on the replica server, and an updated fractional portion updated by using a plurality of change types stored in a change record in a database. A client computer is connected to the fractional replica having knowledge of only the fractional replica of the entry.

In one aspect, the invention involves a directory server system allowing fractional replication, including a means for determining a fractional portion of an entry stored on a primary server using a replication agreement, a means for replicating the fractional portion from the primary server to a replica server creating a fractional replica, and a means for connecting a client computer to the fractional replica. The client computer has knowledge of only the fractional replica.

In one aspect, the invention involves a directory server system allowing fractional replication including a means for determining a fractional portion of an entry stored on a primary server using a replication agreement, a means for replicating the fractional portion from the primary server to a replica server creating a fractional replica, a means for connecting a client computer to the fractional replica, a means for using a query rule to govern responses to questions in the absence of entries on the replica server, a means for using a query rule to govern responses to questions in the absence of attributes of the entry on the replica server, and a means for updating the fractional portion using a plurality of change types stored in a change record in a database. The client computer has knowledge of only the fractional replica.

Other aspects and advantages of the invention will be apparent from the following description and the appended claims.

### BRIEF DESCRIPTION OF DRAWINGS

FIG. 1 illustrates a multiple platform environment.

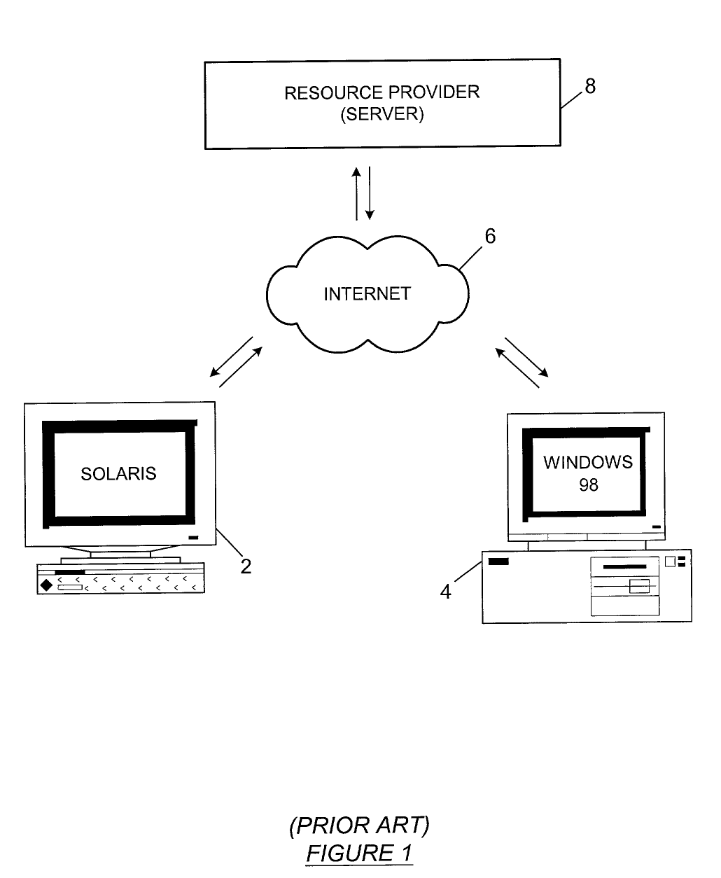

FIG. 2 illustrates a block diagram of iPlanet™ Internet Service Development Platform.

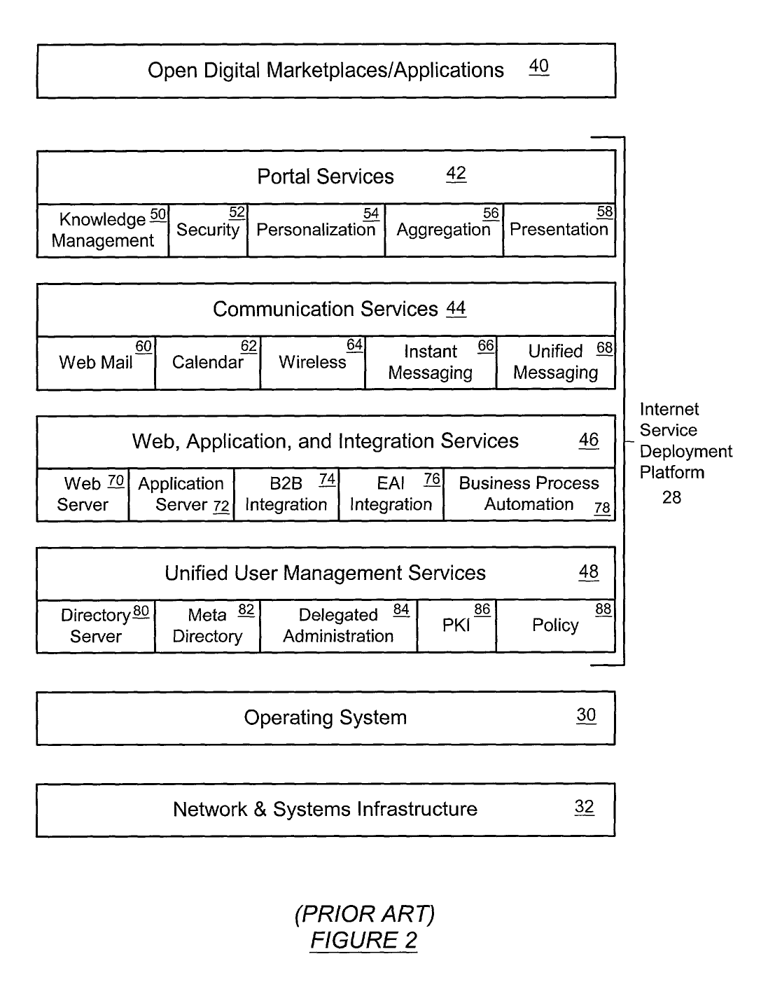

FIG. 3 illustrates part of a typical directory.

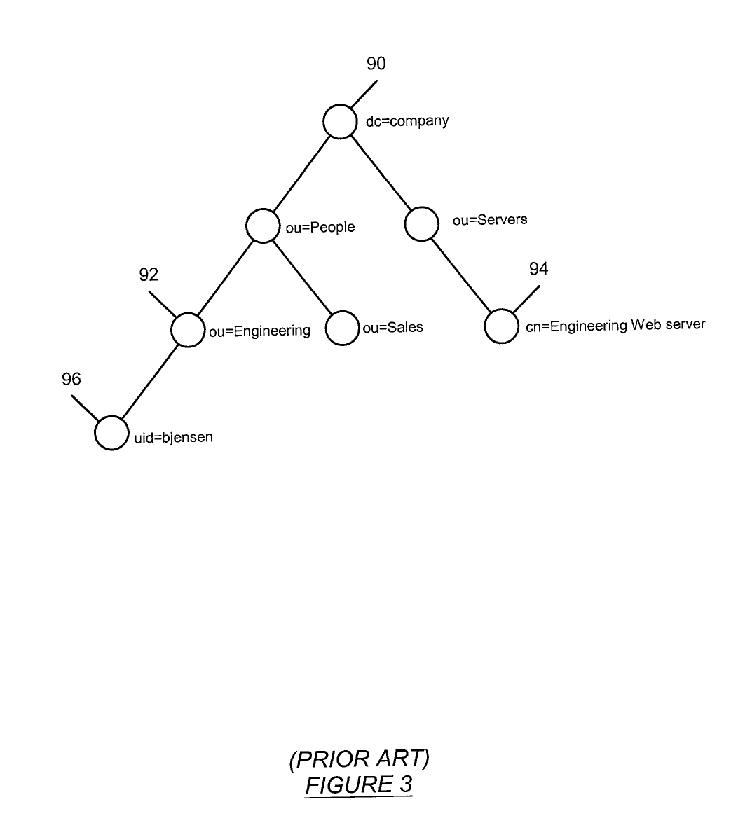

FIG. 4 illustrates the LDAP protocol used for a simple request.

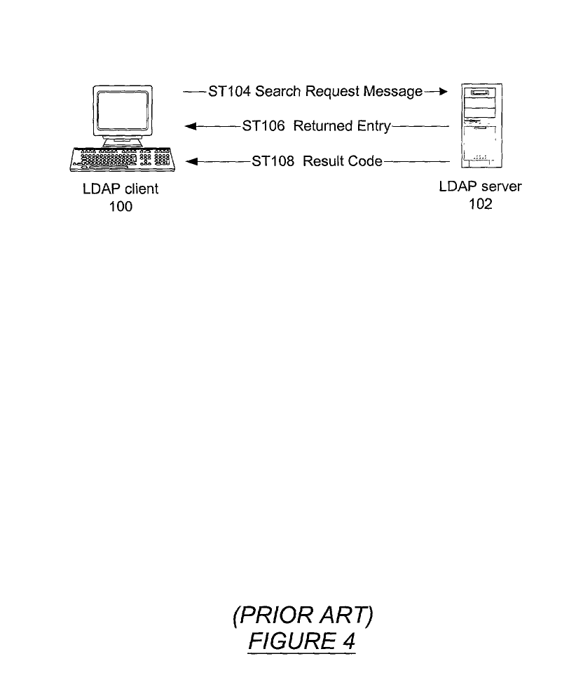

FIG. 5 illustrates a directory entry showing attribute types and values.

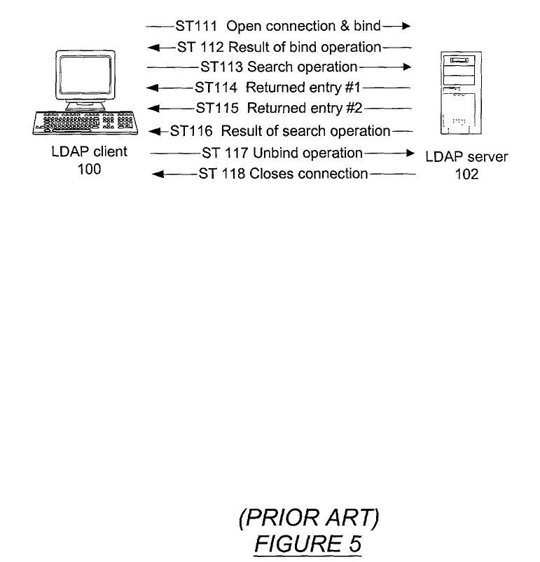

FIG. 6 illustrates a typical LDAP exchange between the LDAP client and LDAP server.

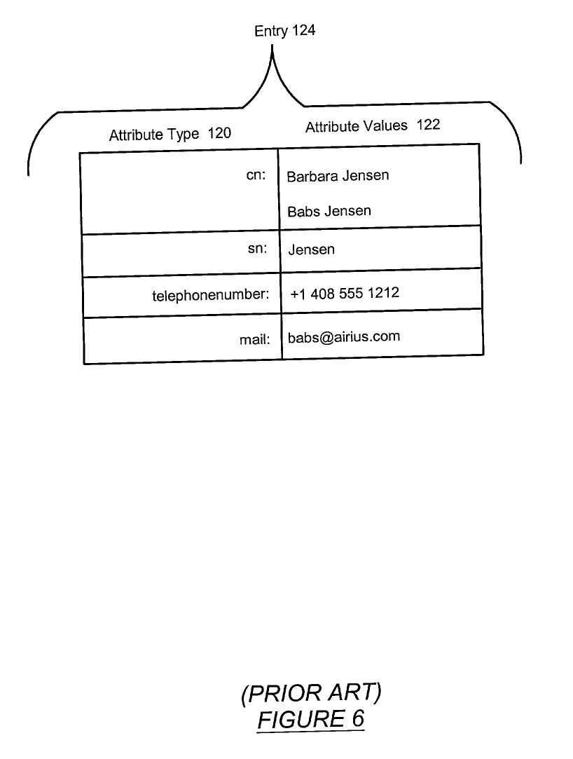

FIG. 7 illustrates replicating an entire subtree onto the replica server.

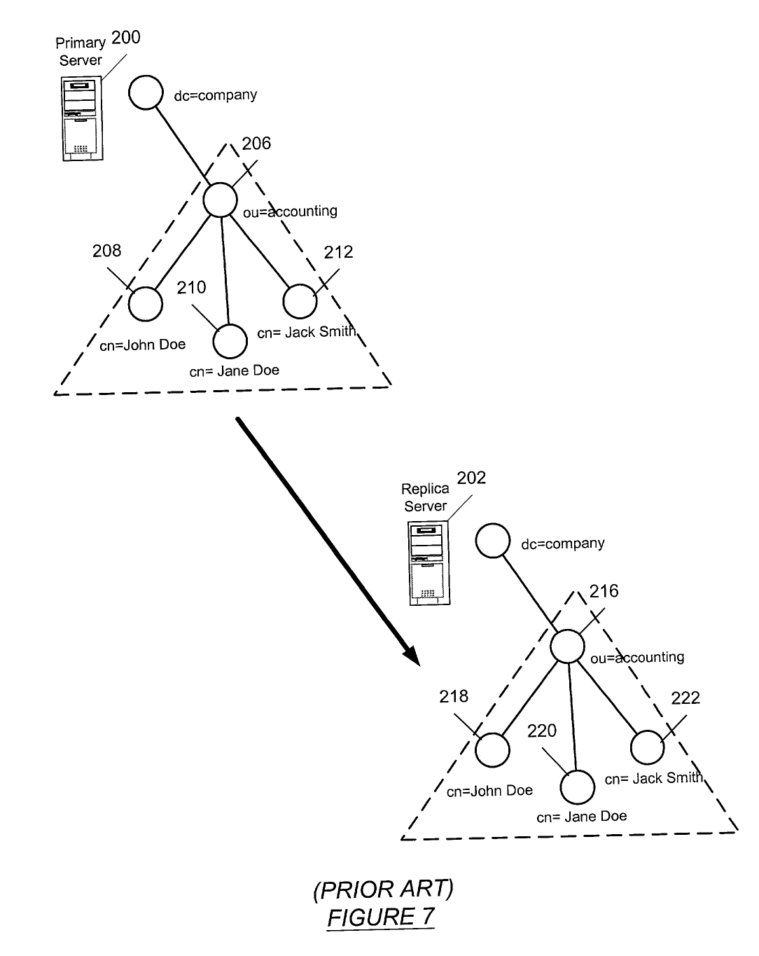

FIG. 8 illustrates sparse replication of selected entries onto the replica server.

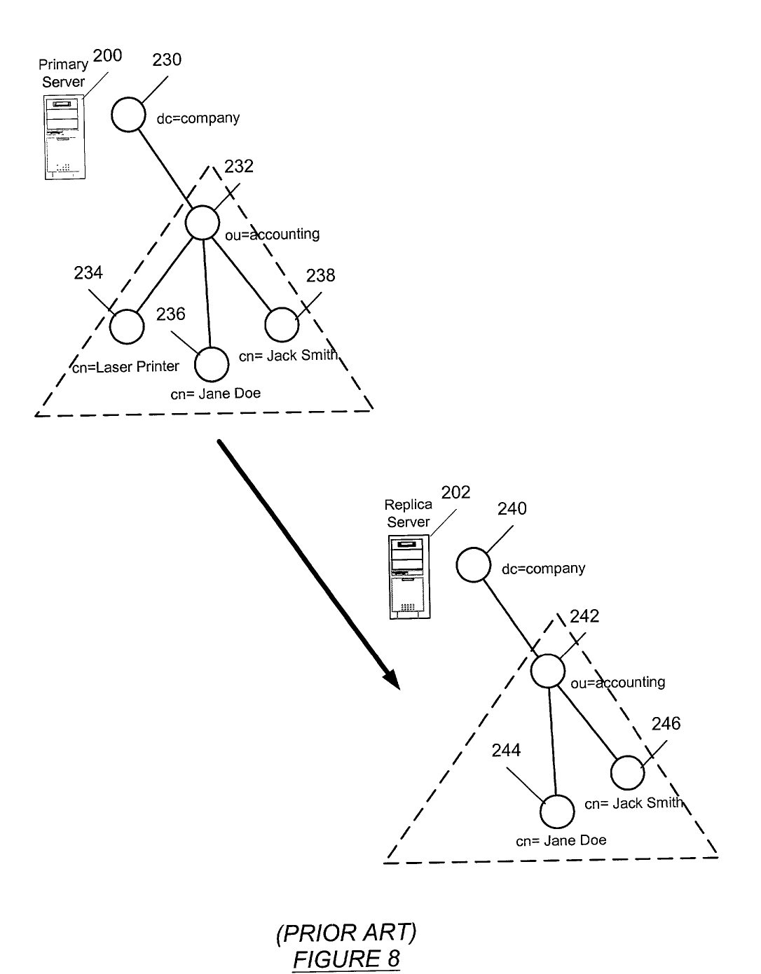

FIG. 9 illustrates fractional replication of selected attributes from an entry onto the replica server.

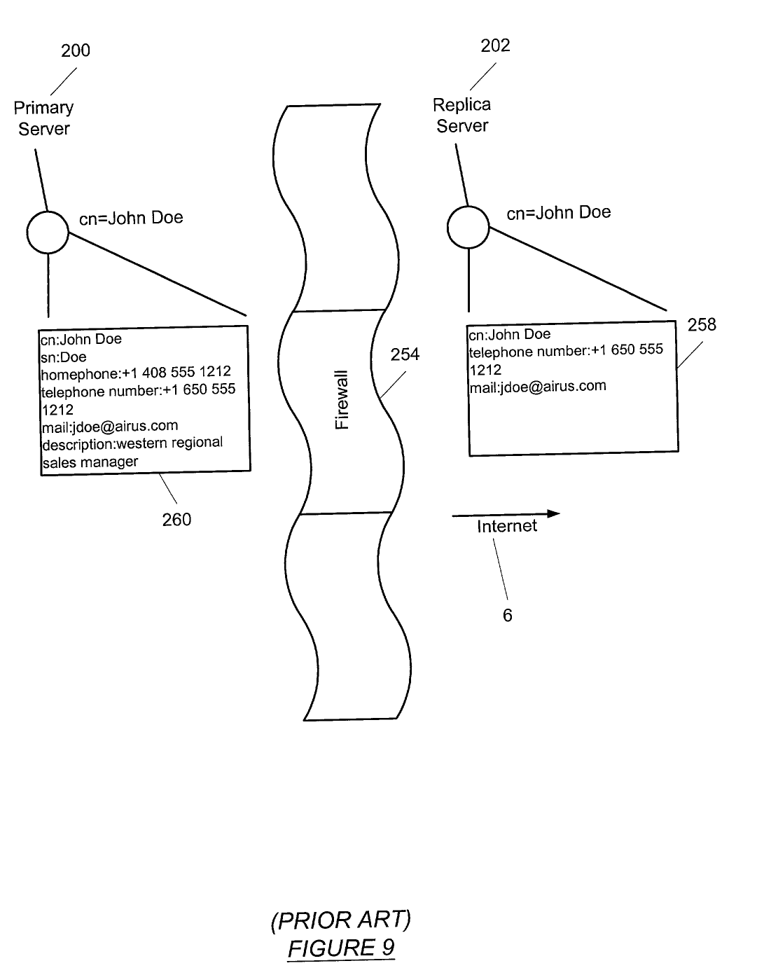

FIG. 10 illustrates a typical computer with components.

FIG. 11 illustrates a typical networked workgroup.

FIG. 12 illustrates fractional replication in one embodiment of the invention.

FIG. 13 illustrates a flowchart of an add operation to update a fractional replica in one embodiment of the invention.

FIG. 14 illustrates a flowchart of a modification operation to update a fractional replica in one embodiment of the invention.

### DETAILED DESCRIPTION

Specific embodiments of the invention will now be described in detail with reference to the accompanying figures. Like elements in the various figures are denoted by like reference numerals for consistency.

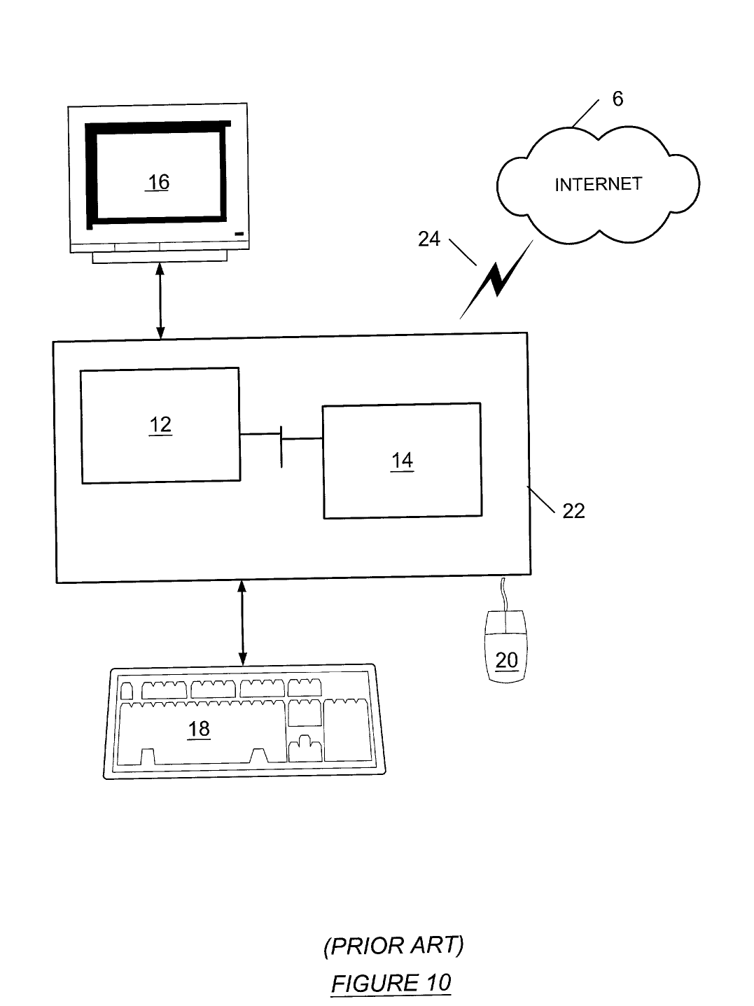

The invention described here may be implemented on virtually any type computer regardless of the traditional platform being used. For example, as shown in FIG. 10, a typical computer (22) has a processor (12), associated storage element (14), and numerous other elements and functionalities typical to today's computers (not shown). The computer (22) has associated therewith input means such as a keyboard (18) and a mouse (20), although in a given accessible environment these input means may take other forms. The computer (22) is also associated with an output device such as a display (16), which also may take a different form in a given accessible environment. Computer (22) is connected via a connection means (24) to the Internet (6).

Directory servers have been used as a corporate infrastructure component for over a decade. The directory server concept has evolved substantially over this time. Today, the directory industry roughly comprises three major categories: Network Operating Systems (NOS) Directories, Meta-directories, and Application Directories.

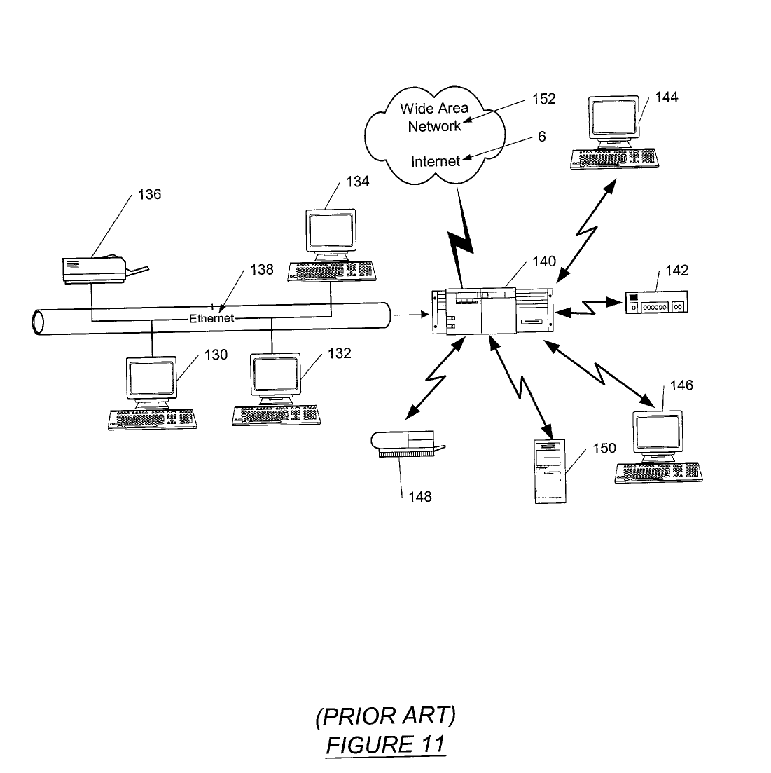

NOS directories are the oldest. These directories serve as information storage systems for the NOS. NOS directories are designed to support print-sharing and file-sharing requirements for small to medium-sized networked workgroups as shown in FIG. 11. The network workgroup shows a first client (130), a second client (132), a third client (134), and a shared printer (136) with an Ethernet connection (138) at one location. Using a router (140), a connection is made to a remote network via a hub (142). Connected to the hub (142) is a remote shared printer (148), a first remote client (144), a second remote client (146), and a file server (150). The entire networked workgroup is able to connect to a wide area network (152) or the Internet (6) via the router (140). NOS directories are also tightly integrated with the operating system. Typical NOS directories include Microsoft® NT Domain Directory and Active Directory for Windows® 2000, Novell Directory Services (NDS), and Sun Microsystems Network Information Service (NIS) for UNIX.

The creation of Meta-directories is a result of the increase in requirement of the directory server from the explosion of e-mail communication. Meta-directories use standard protocols and proprietary connections for synchronizing email systems. However, Meta-directories go beyond e-mail synchronization. Meta-directories integrate key legacy data-systems into a standards-based directory for use by one or more corporate Intranet applications.

Application directories store user information, such as employee, partner, vendor, and customer information, in a single repository for access by multiple applications across multiple heterogeneous systems for up to millions of users. Application directories provide storage for user information, user authentication and access control, and provide the foundation for security for many Internet applications. The primary purpose of an application directory is to support Intranet and E-commerce applications. Application directories serve this role by having such features as Meta-directory capabilities, high-performance, scalability and reliability.

iPlanet™ Directory Server (iDS) is an application directory and delivers user-management infrastructure for managing large volumes of user information for e-business applications and services. The iDS is a high performance, scalable LDAP Server with an on-disk database. The iDS is able to function on a variety of platforms, including Windows® NT, Windows® 2000 and a wide range of UNIX compliant platforms.

The present invention involves fractional replication in a directory server.

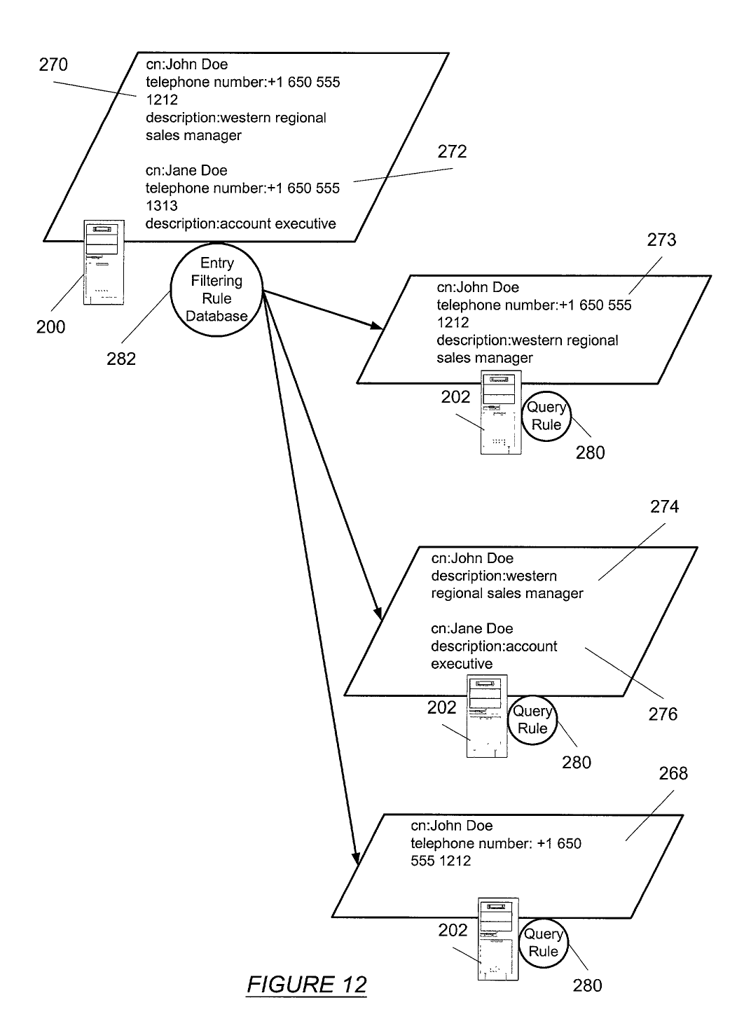

Fractional replication as implemented in the iDS replicates the entry to a replica server or replicates selected attributes of an entry to the replica server resulting in a fractional replica. Referring to FIG. 12, the primary server database (200) has a first entry (John Smith) (270) and a second entry (Jane Doe) (272). Both the first (270) and second entries (272) have a common name attribute, a telephone number attribute, and an assigned role attribute. With fractional replication, an Entry Filtering Rule Database (282) is used to determine which entry or which attributes of the entry are replicated. The Entry Filtering Rule Database (282) has a set of entry filtering rules that govern how to specify what information that is included or excluded from a list sent to the replica server.

In the oversimplified example set forth in FIG. 12, if the entry filtering rule specifies a replica where only a first entry (270) is replicated then the result is a sparse first entry (273) replicated to the replica server (202). If the entry filtering rule specifies a replica where the telephone number attribute of the first entry (270) and a second entry (272) are excluded, then the result is a fractional first entry (274) and a fractional second entry (276) replicated to the replica server (202). If the entry filtering rule specifies a replica where the telephone number attribute of the first entry (270) only is excluded, then the result is a sparse fractional entry (278) replicated to the replica server (202).

Referring to FIG. 12, as part of fractional replication, a query rule (280) exists for each replica server (202). The query rule (280) governs the way to answer questions in the absence of entries or attributes on the replica server (202). The query rule (280) also dictates what information is disclosed to a LDAP client.

A list of replicated attribute types is held in a replicatedAttributes element of a replication agreement. Syntax of this element using Augmented Backus-Naur Form (ABNF) as described in Internet Engineering Task Force (IETF) Request for Comments (RFC) 2234 is: replicatedAttributes::=0,1 (“INCLUDE”/“EXCLUDE”1*(SPACE attribute-type)), where attribute-type is an AttributeDescription. The AttributeDescription is a superset of the definition of AttributeType, but allows additional option to be specified. AttributeType takes on as its value the textual string associated with a specific AttributeType in a specification. In one embodiment, three possible alternatives exist as to which attributes are replicated under this replication agreement. First, if no replicatedAttributes element is present in the replication agreement, then all attributes are replicated. Next, if an INCLUDE list is present, then only attributes in the INCLUDE list are replicated. Last, if an EXCLUDE list is present, then all attributes except those attributes in the EXCLUDE list are replicated. Specifying both the INCLUDE and the EXCLUDE list is not permitted. Likewise, specifying the INCLUDE or the EXCLUDE list without the attribute list is not permitted. Attributes required by the replication schema are always replicated, even if implicitly or explicitly excluded, unless a system administrator overrides the replication via a configuration option.

The fractional replica provides no clue to the LDAP client that the information stored in the replicated entries is fractional in nature. The LDAP client connecting to the fractional replica only has knowledge about the attributes present. The LDAP client, by design, does not have any way of knowing additional attributes of the entries are present elsewhere.

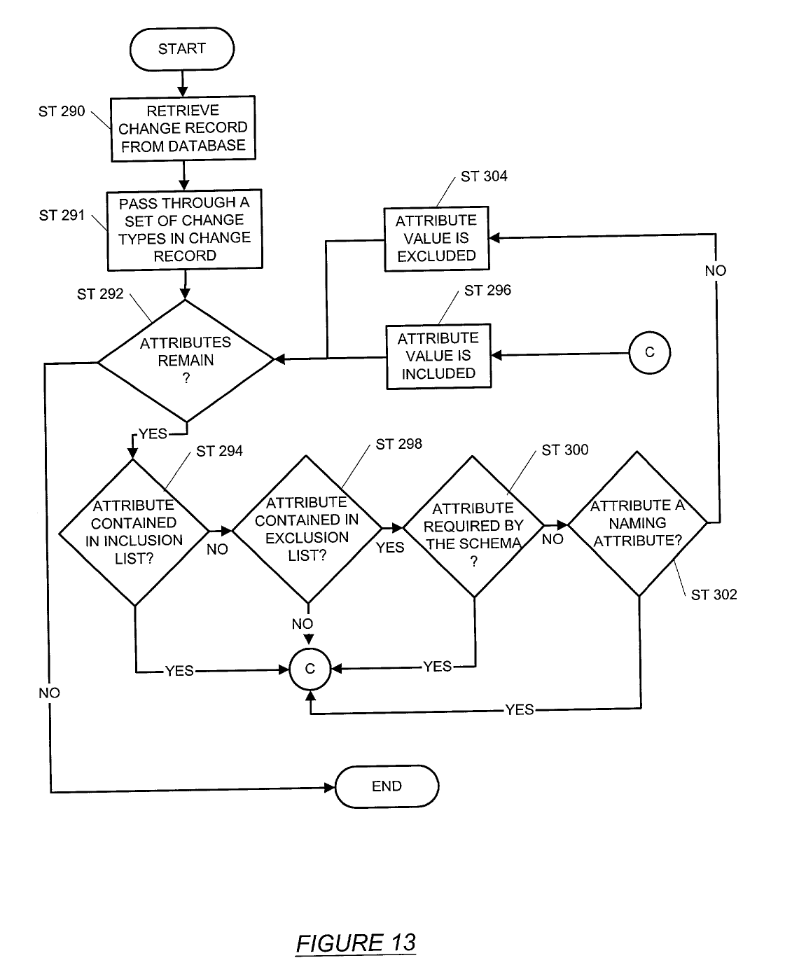

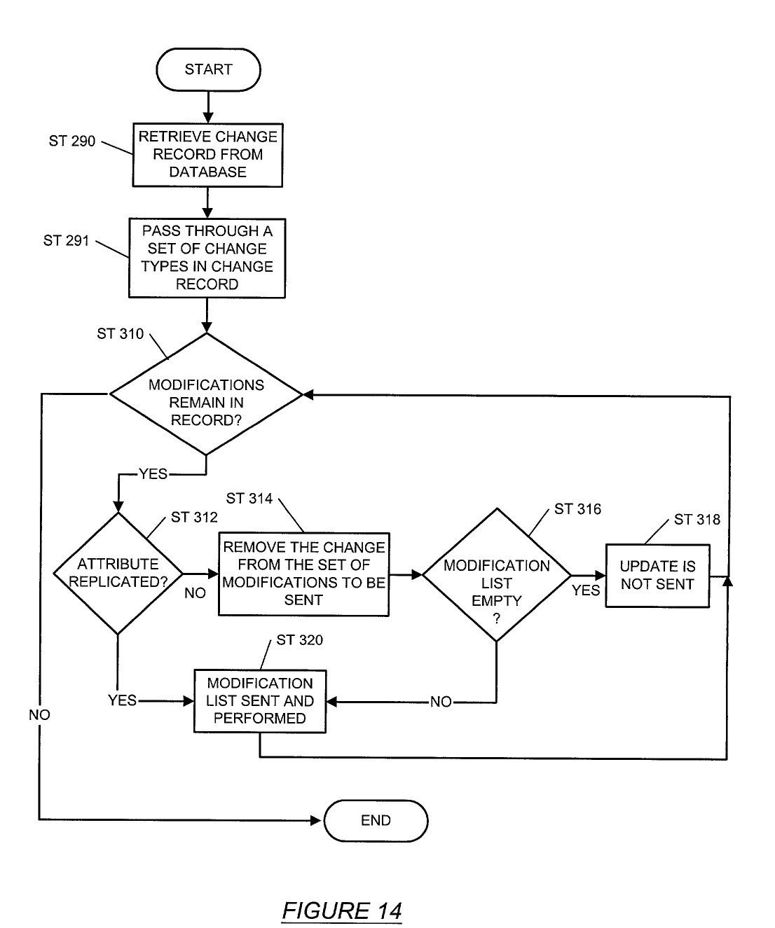

Referring to FIGS. 13 and 14, when transmitting updates to the fractional replica, a first step is to retrieve a change record from a database (step 290). Next, a pass through of a set of change types in the change record is made (step 291). For each change type (add, delete, modify, and moddn operations), a different algorithm is used.

For an add operation as shown in FIG. 13, a list of attributes being added to the entry is traversed until no attributes remain (step 292). If the attribute type is contained in the inclusion list (step 294) or attribute type is not contained in the exclusion list (step 298), then the attribute value is included (step 296).

Otherwise, if the attribute is required by the schema (step 300) or the attribute value is a naming attribute for the entry (step 302), then include the attribute value (step 296). Otherwise, exclude the attribute value (step 304). The algorithm for the add operation never removes all attributes from the entry because all required attributes are always included.

For a delete operation, no action is required. The delete operation is replayed unaltered to perform as usual.

For a modify operation as shown in FIG. 14, a list of modifications being applied to the entry is traversed until no modifications remain (step 310). If the attribute type is not replicated (step 312), then remove the change from the set of modification to be sent (step 314). If the modification list is empty (step 316) then the update is not sent (step 318). Otherwise, the modification is sent and performed (step 320).

For a moddn operation, the purpose of the action is to handle a case where the attribute value is replicated because the attribute value was a naming attribute of the entry, but no longer is the naming attribute after application of the moddn operation. In this case, that attribute is removed from the fractional replica because the condition, which required inclusion of the attribute no longer, holds true.

In one embodiment of the invention, all of the following conditions must hold true in order to use fractional replication. The supplier and consumer servers must adhere to the standards of the iDS fractional replication. The consumer server must be a read-only server and must not be supplied by more than one server.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of fractional replication in a directory server, comprising:
determining a fractional portion of an entry stored on a primary server using a replication agreement;
replicating the fractional portion from the primary server to a replica server creating a fractional replica; and
connecting a client computer to the fractional replica;
wherein the client computer has knowledge of only the fractional replica.

2. The method of claim 1, further comprising:
using a query rule to govern responses to questions in the absence of entries on the replica server.

3. The method of claim 1, further comprising:
using a query rule to govern responses to questions in the absence of attributes of the entry on the replica server.

4. The method of claim 1, further comprising:
updating the fractional portion using a plurality of change types stored in a change record in a database.

5. The method of claim 1, wherein an entry filtering rule database is stored in the replication agreement.

6. The method of claim 1, wherein the replication agreement comprises a list of replicated attribute types held in an element.

7. The method of claim 6, wherein the element is empty and all attributes of the entry are to be replicated.

8. The method of claim 6, wherein the list of replicated attribute types comprises an include list.

9. The method of claim 6, wherein the list of replicated attribute types comprises an exclude list.

10. A method of fractional replication in a directory server, comprising:
determining a fractional portion of an entry stored on a primary server using a replication agreement;
replicating the fractional portion from the primary server to a replica server creating a fractional replica;
using a query rule to govern responses to questions in the absence of entries on the replica server;
using a query rule to govern responses to questions in the absence of attributes of the entry on the replica server;
updating the fractional portion using a plurality of change types stored in a change record in a database; and
connecting a client computer to the fractional replica;
wherein the client computer has knowledge of only the fractional replica.

11. A method of transmitting updates to a fractional portion, comprising:
retrieving a change record stored in a database;
making a pass-through of a plurality of change types from the change record stored in the database; and
performing an update function to the fractional portion based on the change type.

12. The method of claim 10, wherein the change type comprises an add operation.

13. The method of claim 10, wherein the change type comprises a delete operation

14. The method of claim 10, wherein the change type comprises a modify operation.

15. The method of claim 10, wherein the change type comprises a moddn operation.

16. A directory server system allowing fractional replication, comprising:
a primary server database comprising a plurality of entries;
an entry filtering rule database to determine a fractional portion of an entry stored on the primary server to be replicated using a replication agreement; and
a replica server that replicates the fractional portion received from the primary server creating a fractional replica;
wherein a client computer is connected to the fractional replica having knowledge of only the fractional replica of the entry.

17. The system of claim 16, further comprising:
a query rule to govern responses to questions in the absence of entries on the replica server.

18. The system of claim 16, further comprising:
a query rule to govern responses to questions in the absence of attributes of the entry on the replica server.

19. The system of claim 16, further comprising:
an updated fractional portion updated by using a plurality of change types stored in a change record in a database.

20. The system of claim 16, wherein the replication agreement comprises a list of replicated attribute types held in an element.

21. The system of claim 20, wherein the element is empty and all attributes of the entry are to be replicated.

22. The system of claim 20, wherein the list of replicated attribute types comprises an include list.

23. The system of claim 20, wherein the list of replicated attribute types comprises an exclude list.

24. A directory server system allowing fractional replication, comprising:
a primary server database comprising a plurality of entries;
an entry filtering rule database to determine a fractional portion of an entry stored on the primary server to be replicated using a replication agreement;
a replica server replicates the fractional portion received from the primary server creating a fractional replica;
a query rule to govern responses to questions in the absence of entries on the replica server;
a query rule to govern responses to questions in the absence of attributes of the entry on the replica server; and
an updated fractional portion updated by using a plurality of change types stored in a change record in a database;
wherein a client computer is connected to the fractional replica having knowledge of only the fractional replica of the entry.

25. A directory server system allowing fractional replication, comprising:
means for determining a fractional portion of an entry stored on a primary server using a replication agreement;
means for replicating the fractional portion from the primary server to a replica server creating a fractional replica; and
means for connecting a client computer to the fractional replica;
wherein the client computer has knowledge of only the fractional replica.

26. The system of claim 25, further comprising:
means for using a query rule to govern responses to questions in the absence of entries on the replica server.

27. The system of claim 25, further comprising:
means for using a query rule to govern responses to questions in the absence of attributes of the entry on the replica server.

28. The system of claim 25, further comprising:
means for updating the fractional portion using a plurality of change types stored in a change record in a database.

29. A directory server system allowing fractional replication, comprising:
means for determining a fractional portion of an entry stored on a primary server using a replication agreement;
means for replicating the fractional portion from the primary server to a replica server creating a fractional replica;
means for connecting a client computer to the fractional replica;
means for using a query rule to govern responses to questions in the absence of entries on the replica server;
means for using a query rule to govern responses to questions in the absence of attributes of the entry on the replica server; and
means for updating the fractional portion using a plurality of change types stored in a change record in a database;
wherein the client computer has knowledge of only the fractional replica.
